(19) United States
(12) Patent Application Publication
(10) Pub. No.: US 2008/0013107 A1
(43) Pub. Date: Jan. 17, 2008

(54) Generating a profile model to characterize a structure to be examined using optical metrology

(75) Inventors: Jeffrey A. Chard, Sunnyvale, CA (US); Junwei Bao, Palo Alto, CA (US); Joerg Bischoff, Illmenau (DE); Shifang Li, Pleasanton, CA (US); Wei Liu, Santa Clara, CA (US); Hong Qiu, Union City, CA (US); Sylvio Rabello, Palo Alto, CA (US); Vi Vuong, Fremont, CA (US)

Correspondence Address: MORRISON & FOERSTER LLP, 425 MARKET STREET, SAN FRANCISCO, CA, 94105-2482, US

(73) Assignee: Tokyo Electron Limited, Tokyo (JP)

(21) Appl. No.: 11/484,974

(22) Filed: Jul. 11, 2006

(51) Int. Cl. G01B 11/14

(52) U.S. Cl. 356/625

(57) ABSTRACT

In generating a profile model to characterize a structure to be examined using optical metrology, a view canvas is displayed, with the profile model being generated displayed in the view canvas. A profile shape palette is displayed adjacent to the view canvas. A plurality of different profile shape primitives is displayed in the profile shape palette. Each profile shape primitive in the profile shape palette is defined by a set of profile parameters. When a user selects a profile shape primitive from the profile shape palette, drags the selected profile shape primitive from the profile shape palette, and drops the selected profile shape primitive into the view canvas, the selected profile shape primitive is incorporated into the profile model being generated and displayed in the view canvas.

### BACKGROUND

1. Field

The present application generally relates to optical metrology of a structure formed on a semiconductor wafer, and, more particularly, to generating a profile model to characterize the structure to be examined using optical metrology.

2. Description of the Related Art

Optical metrology involves directing an incident beam at a structure, measuring the resulting diffracted beam, and analyzing the diffracted beam to determine a feature of the structure. In semiconductor manufacturing, optical metrology is typically used for quality assurance. For example, after fabricating a structure on a semiconductor wafer, an optical metrology tool is used to determine the profile of the structure. By determining the profile of the structure, the quality of the fabrication process utilized to form the structure can be evaluated.

In one conventional optical metrology system, a diffraction signal collected from illuminating a structure (a measured diffraction signal) is compared to simulated diffraction signals, which are associated with hypothetical profiles of the structure. When a match is found between the measured diffraction signal and one of the simulated diffraction signals, the hypothetical profile associated with the matching simulated diffraction signal is presumed to represent the actual profile of the structure.

The hypothetical profiles, which are used to generate the simulated diffraction signals, are generated based on a profile model that characterizes the structure to be examined. Thus, in order to accurately determine the profile of the structure using optical metrology, a profile model that accurately characterizes the structure should be used.

### SUMMARY

In one exemplary embodiment, in generating a profile model to characterize a structure to be examined using optical metrology, a view canvas is displayed, with the profile model being generated displayed in the view canvas. A profile shape palette is displayed adjacent to the view canvas. A plurality of different profile shape primitives is displayed in the profile shape palette. Each profile shape primitive in the profile shape palette is defined by a set of profile parameters. When a user selects a profile shape primitive from the profile shape palette, drags the selected profile shape primitive from the profile shape palette, and drops the selected profile shape primitive into the view canvas, the selected profile shape primitive is incorporated into the profile model being generated and displayed in the view canvas.

### DESCRIPTION OF THE DRAWING FIGURES

FIG. 1 depicts an exemplary optical metrology system;

FIGS. 2A-2E depict exemplary profile models;

FIG. 3 depicts an exemplary profile that varies only in one dimension;

FIG. 4 depicts an exemplary profile that varies in two dimensions;

FIGS. 5A, 5B, and 5C depict characterization of two-dimension repeating structures;

FIG. 6 depicts an exemplary process of generating a profile model;

FIG. 7 depicts an exemplary process of assigning materials to a profile model;

FIGS. 8A-8L depict an exemplary profile model being generated and materials being assigned to the exemplary profile model;

FIGS. 9A and 9B depict an exemplary profile of a two-dimension repeating structure being generated; and

FIG. 10 depicts an exemplary computer system.

### DETAILED DESCRIPTION

The following description sets forth numerous specific configurations, parameters, and the like. It should be recognized, however, that such description is not intended as a limitation on the scope of the present invention, but is instead provided as a description of exemplary embodiments.

### 1. Optical Metrology Tools

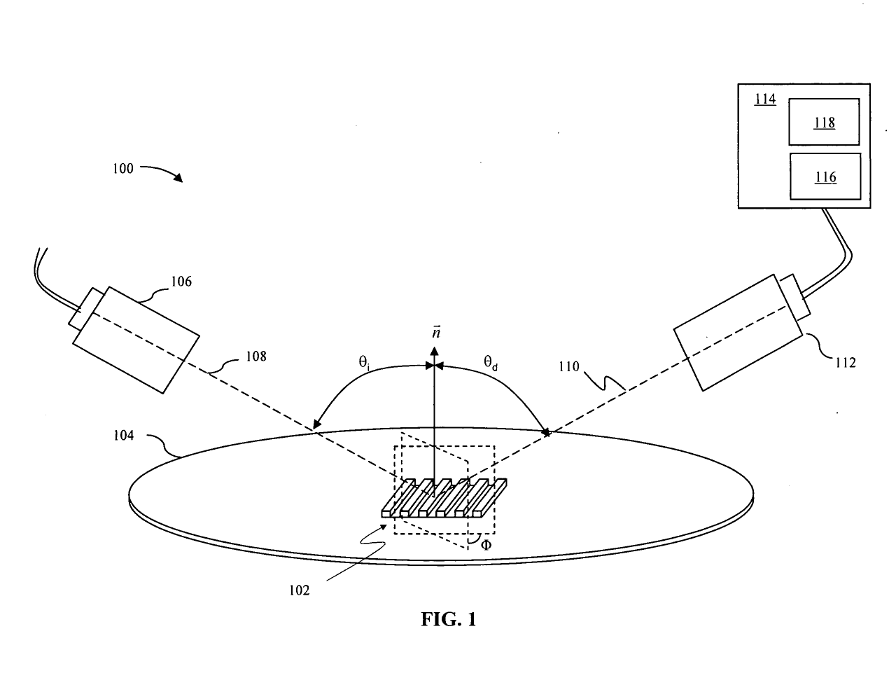

With reference to FIG. 1, an optical metrology system 100 can be used to examine and analyze a structure formed on a semiconductor wafer 104. For example, optical metrology system 100 can be used to determine one or more features of a periodic grating 102 formed on wafer 104. As described earlier, periodic grating 102 can be formed in a test pad on wafer 104, such as adjacent to a die formed on wafer 104. Periodic grating 102 can be formed in a scribe line and/or an area of the die that does not interfere with the operation of the die.

As depicted in FIG. 1, optical metrology system 100 can include a photometric device with a source 106 and a detector 112. Periodic grating 102 is illuminated by an incident beam 108 from source 106. The incident beam 108 is directed onto periodic grating 102 at an angle of incidence θᵢ; with respect to normal \vec{n} of periodic grating 102 and an azimuth angle Φ (i.e., the angle between the plane of incidence beam 108 and the direction of the periodicity of periodic grating 102). Diffracted beam 110 leaves at an angle of θ_{d} with respect to normal and is received by detector 112. Detector 112 converts the diffracted beam 110 into a measured diffraction signal, which can include reflectance, tan (Ψ), cos(Δ), Fourier coefficients, and the like. Although a zero-order diffraction signal is depicted in FIG. 1, it should be recognized that non-zero orders can also be used. For example, see Ausschnitt, Christopher P., “A New Approach to Pattern Metrology,” Proc. SPIE 5375-7, Feb. 23, 2004, pp 1-15, which is incorporated herein by reference in its entirety.

Optical metrology system 100 also includes a processing module 114 configured to receive the measured diffraction signal and analyze the measured diffraction signal. The processing module is configured to determine one or more features of the periodic grating using any number of methods which provide a best matching diffraction signal to the measured diffraction signal. These methods have been described elsewhere and include a library-based process, or a regression based process using simulated diffraction signals obtained by rigorous coupled wave analysis and machine learning systems.

### 2. Library-Based Process of Determining Feature of Structure

In a library-based process of determining one or more features of a structure, the measured diffraction signal is compared to a library of simulated diffraction signals. More specifically, each simulated diffraction signal in the library is associated with a hypothetical profile of the structure. When a match is made between the measured diffraction signal and one of the simulated diffraction signals in the library or when the difference of the measured diffraction signal and one of the simulated diffraction signals is within a preset or matching criterion, the hypothetical profile associated with the matching simulated diffraction signal is presumed to represent the actual profile of the structure. The matching simulated diffraction signal and/or hypothetical profile can then be utilized to determine whether the structure has been fabricated according to specifications.

Thus, with reference again to FIG. 1, in one exemplary embodiment, after obtaining a measured diffraction signal, processing module 114 then compares the measured diffraction signal to simulated diffraction signals stored in a library 116. Each simulated diffraction signal in library 116 can be associated with a hypothetical profile. Thus, when a match is made between the measured diffraction signal and one of the simulated diffraction signals in library 116, the hypothetical profile associated with the matching simulated diffraction signal can be presumed to represent the actual profile of periodic grating 102.

The set of hypothetical profiles stored in library 116 can be generated by characterizing the profile of periodic grating 102 using a profile model. The profile model is characterized using a set of profile parameters. The profile parameters in the set are varied to generate hypothetical profiles of varying shapes and dimensions. The process of characterizing the actual profile of periodic grating 102 using profile model and a set of profile parameters can be referred to as parameterizing.

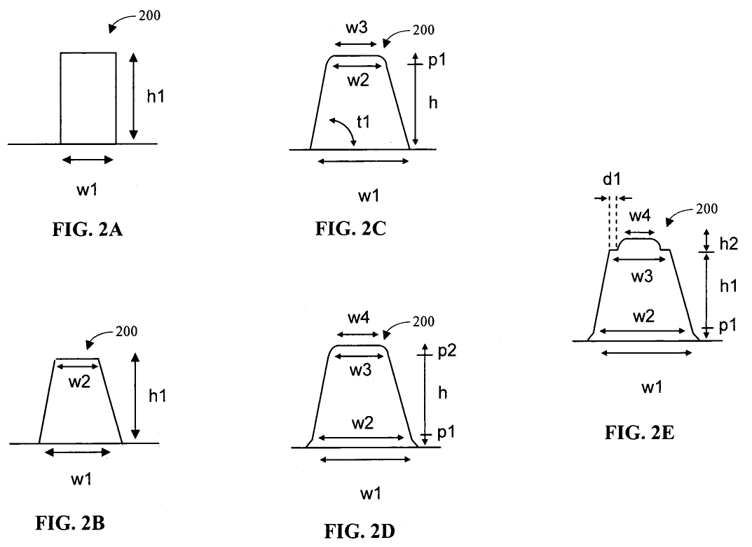

For example, as depicted in FIG. 2A, assume that profile model 200 can be characterized by profile parameters h1 and w1 that define its height and width, respectively. As depicted in FIGS. 2B to 2E, additional shapes and features of profile model 200 can be characterized by increasing the number of profile parameters. For example, as depicted in FIG. 2B, profile model 200 can be characterized by profile parameters h1, w1, and w2 that define its height, bottom width, and top width, respectively. Note that the width of profile model 200 can be referred to as the critical dimension (CD). For example, in FIG. 2B, profile parameter w1 and w2 can be described as defining the bottom CD (BCD) and top CD (TCD), respectively, of profile model 200.

As described above, the set of hypothetical profiles stored in library 116 (FIG. 1) can be generated by varying the profile parameters that characterize the profile model. For example, with reference to FIG. 2B, by varying profile parameters h1, w1, and w2, hypothetical profiles of varying shapes and dimensions can be generated. Note that one, two, or all three profile parameters can be varied relative to one another.

With reference again to FIG. 1, the number of hypothetical profiles and corresponding simulated diffraction signals in the set of hypothetical profiles and simulated diffraction signals stored in library 116 (i.e., the resolution and/or range of library 116) depends, in part, on the range over which the set of profile parameters and the increment at which the set of profile parameters is varied. The hypothetical profiles and the simulated diffraction signals stored in library 116 are generated prior to obtaining a measured diffraction signal from an actual structure. Thus, the range and increment (i.e., the range and resolution) used in generating library 116 can be selected based on familiarity with the fabrication process for a structure and what the range of variance is likely to be. The range and/or resolution of library 116 can also be selected based on empirical measures, such as measurements using AFM, X-SEM, and the like.

For a more detailed description of a library-based process, see U.S. patent application Ser. No. 09/907,488, titled GENERATION OF A LIBRARY OF PERIODIC GRATING DIFFRACTION SIGNALS, filed on Jul. 16, 2001, which is incorporated herein by reference in its entirety.

### 3. Regression-Based Process of Determining Feature of Structure

In a regression-based process of determining one or more features of a structure, the measured diffraction signal is compared to a simulated diffraction signal (i.e., a trial diffraction signal). The simulated diffraction signal is generated prior to the comparison using a set of profile parameters (i.e., trial profile parameters) for a hypothetical profile. If the measured diffraction signal and the simulated diffraction signal do not match or when the difference of the measured diffraction signal and one of the simulated diffraction signals is not within a preset or matching criterion, another simulated diffraction signal is generated using another set of profile parameters for another hypothetical profile, then the measured diffraction signal and the newly generated simulated diffraction signal are compared. When the measured diffraction signal and the simulated diffraction signal match or when the difference of the measured diffraction signal and one of the simulated diffraction signals is within a preset or matching criterion, the hypothetical profile associated with the matching simulated diffraction signal is presumed to represent the actual profile of the structure. The matching simulated diffraction signal and/or hypothetical profile can then be utilized to determine whether the structure has been fabricated according to specifications.

Thus, with reference again to FIG. 1, the processing module 114 can generate a simulated diffraction signal for a hypothetical profile, and then compare the measured diffraction signal to the simulated diffraction signal. As described above, if the measured diffraction signal and the simulated diffraction signal do not match or when the difference of the measured diffraction signal and one of the simulated diffraction signals is not within a preset or matching criterion, then processing module 114 can iteratively generate another simulated diffraction signal for another hypothetical profile. The subsequently generated simulated diffraction signal can be generated using an optimization algorithm, such as global optimization techniques, which includes simulated annealing, and local optimization techniques, which includes steepest descent algorithm.

The simulated diffraction signals and hypothetical profiles can be stored in a library 116 (i.e., a dynamic library). The simulated diffraction signals and hypothetical profiles stored in library 116 can then be subsequently used in matching the measured diffraction signal.

For a more detailed description of a regression-based process, see U.S. patent application Ser. No. 09/923,578, titled METHOD AND SYSTEM OF DYNAMIC LEARNING THROUGH A REGRESSION-BASED LIBRARY GENERATION PROCESS, filed on Aug. 6, 2001, which is incorporated herein by reference in its entirety.

### 4. Rigorous Coupled Wave Analysis

As described above, simulated diffraction signals are generated to be compared to measured diffraction signals. As will be described below, the simulated diffraction signals can be generated by applying Maxwell's equations and using a numerical analysis technique to solve Maxwell's equations. It should be noted, however, that various numerical analysis techniques, including variations of RCWA, can be used.

In general, RCWA involves dividing a hypothetical profile into a number of sections, slices, or slabs (hereafter simply referred to as sections). For each section of the hypothetical profile, a system of coupled differential equations is generated using a Fourier expansion of Maxwell's equations (i.e., the components of the electromagnetic field and permittivity (ε)). The system of differential equations is then solved using a diagonalization procedure that involves eigenvalue and eigenvector decomposition (i.e., Eigen-decomposition) of the characteristic matrix of the related differential equation system. Finally, the solutions for each section of the hypothetical profile are coupled using a recursive-coupling schema, such as a scattering matrix approach. For a description of a scattering matrix approach, see Lifeng Li, “Formulation and comparison of two recursive matrix algorithms for modeling layered diffraction gratings,” J. Opt. Soc. Am. A13, pp 1024-1035 (1996), which is incorporated herein by reference in its entirety. For a more detail description of RCWA, see U.S. patent application Ser. No. 09/770,997, titled CACHING OF INTRA-LAYER CALCULATIONS FOR RAPID RIGOROUS COUPLED-WAVE ANALYSES, filed on Jan. 25, 2001, which is incorporated herein by reference in its entirety.

### 5. Machine Learning Systems

The simulated diffraction signals can be generated using a machine learning system (MLS) employing a machine learning algorithm, such as back-propagation, radial basis function, support vector, kernel regression, and the like. For a more detailed description of machine learning systems and algorithms, see “Neural Networks” by Simon Haykin, Prentice Hall, 1999, which is incorporated herein by reference in its entirety. See also U.S. patent application Ser. No. 10/608,300, titled OPTICAL METROLOGY OF STRUCTURES FORMED ON SEMICONDUCTOR WAFERS USING MACHINE LEARNING SYSTEMS, filed on Jun. 27, 2003, which is incorporated herein by reference in its entirety.

In one exemplary embodiment, the simulated diffraction signals in a library of diffraction signals, such as library 116 (FIG. 1), used in a library-based process are generated using a MLS. For example, a set of hypothetical profiles can be provided as inputs to the MLS to produce a set of simulated diffraction signals as outputs from the MLS. The set of hypothetical profiles and set of simulated diffraction signals are stored in the library.

In another exemplary embodiment, the simulated diffractions used in regression-based process are generated using a MLS, such as MLS 118 (FIG. 1). For example, an initial hypothetical profile can be provided as an input to the MLS to produce an initial simulated diffraction signal as an output from the MLS. If the initial simulated diffraction signal does not match the measured diffraction signal, another hypothetical profile can be provided as an additional input to the MLS to produce another simulated diffraction signal.

FIG. 1 depicts processing module 114 having both a library 116 and MLS 118. It should be recognized, however, that processing module 114 can have either library 116 or MLS 118 rather than both. For example, if processing module 114 only uses a library-based process, MLS 118 can be omitted. Alternatively, if processing module 114 only uses a regression-based process, library 116, can be omitted. Note, however, a regression-based process can include storing hypothetical profiles and simulated diffraction signals generated during the regression process in a library, such as library 116.

### 6. One Dimension Profiles and Two Dimension Profiles

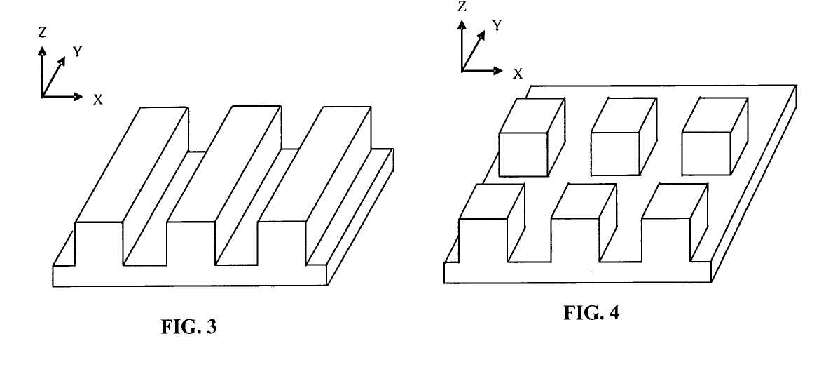

The term “one-dimension structure” is used herein to refer to a structure having a profile that varies only in one dimension. For example, FIG. 3 depicts a periodic grating having a profile that varies in one dimension (i.e., the x-direction). The profile of the periodic grating depicted in FIG. 3 varies in the z-direction as a function of the x-direction. However, the profile of the periodic grating depicted in FIG. 3 is assumed to be substantially uniform or continuous in the y-direction.

The term “two-dimension structure” is used herein to refer to a structure having a profile that varies in at least two-dimensions. For example, FIG. 4 depicts a periodic grating having a profile that varies in two dimensions (i.e., the x-direction and the y-direction). The profile of the periodic grating depicted in FIG. 4 varies in the y-direction.

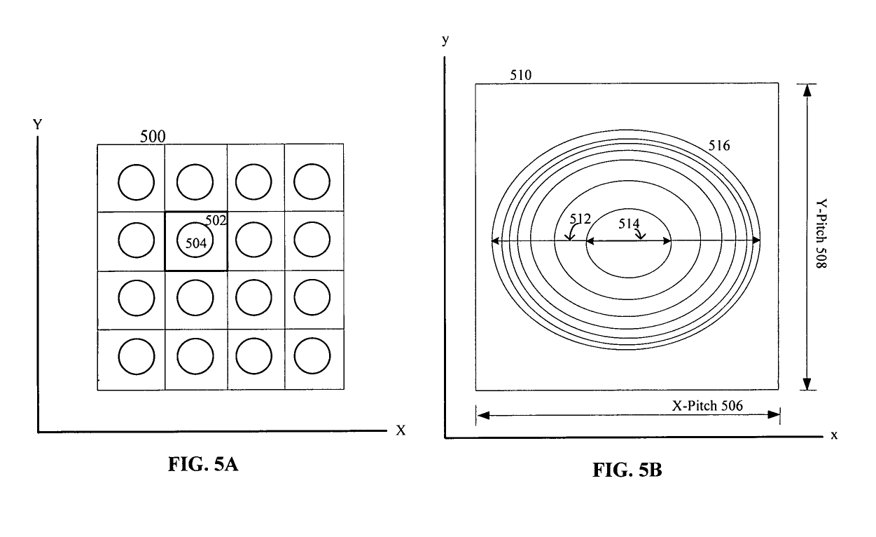

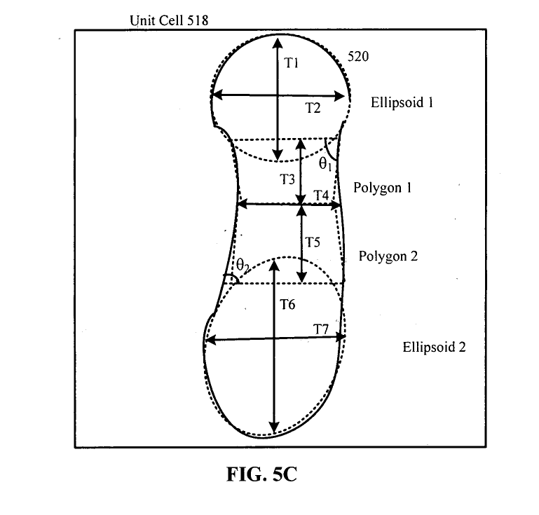

Discussion for FIGS. 5A, 5B, and 5C below describe the characterization of two-dimension repeating structures for optical metrology modeling. FIG. 5A depicts a top-view of exemplary orthogonal grid of unit cells of a two-dimension repeating structure. A hypothetical grid of lines is superimposed on the top-view of the repeating structure where the lines of the grid are drawn along the direction of periodicity. The hypothetical grid of lines forms areas referred to as unit cells. The unit cells may be arranged in an orthogonal or non-orthogonal configuration. Two-dimension repeating structures may comprise features such as repeating posts, contact holes, vias, islands, or combinations of two or more shapes within a unit cell. Furthermore, the features may have a variety of shapes and may be concave or convex features or a combination of concave and convex features. Referring to FIG. 5A, the repeating structure 500 comprises unit cells with holes arranged in an orthogonal manner. Unit cell 502 includes all the features and components inside the unit cell 502, primarily comprising a hole 504 substantially in the center of the unit cell 502.

FIG. 5B depicts a top-view of a two-dimension repeating structure. Unit cell 510 includes a concave elliptical hole. FIG. 5B shows a unit cell 510 with a feature 516 that comprises an elliptical hole wherein the dimensions become progressively smaller until the bottom of the hole. Profile parameters used to characterize the structure includes the X-pitch 506 and the Y-pitch 508. In addition, the major axis of the ellipse 512 that represents the top of the feature 516 and the major axis of the ellipse 514 that represents the bottom of the feature 516 may be used to characterize the feature 516. Furthermore, any intermediate major axis between the top and bottom of the feature may also be used as well as any minor axis of the top, intermediate, or bottom ellipse, (not shown).

FIG. 5C is an exemplary technique for characterizing the top-view of a two-dimension repeating structure. A unit cell 518 of a repeating structure is a feature 520, an island with a peanut-shape viewed from the top. One modeling approach includes approximating the feature 520 with a variable number or combinations of ellipses and polygons. Assume further that after analyzing the variability of the top-view shape of the feature 520, it was determined that two ellipses, Ellipsoid 1 and Ellipsoid 2, and two polygons, Polygon 1 and Polygon 2 were found to fully characterize feature 520. In turn, parameters needed to characterize the two ellipses and two polygons comprise nine parameters as follows: T1 and T2 for Ellipsoid 1; T3, T4, and θ₁ for Polygon 1; T4, T5, and θ₂ for Polygon 2; T6 and T7 for Ellipsoid 2. Many other combinations of shapes could be used to characterize the top-view of the feature 520 in unit cell 518. For a detailed description of modeling two-dimension repeating structures, refer to U.S. patent application Ser. No. 11/061,303, OPTICAL METROLOGY OPTIMIZATION FOR REPETITIVE STRUCTURES, by Vuong, et al., filed on Apr. 27, 2004, and is incorporated in its entirety herein by reference.

### 7. Generating a Profile Model

As described above, in both a library-based process and a regression-based process, a simulated diffraction signal is generated based on a hypothetical profile of the structure to be examined. As also described above, the hypothetical profile is generated based on a profile model that characterizes the structure to be examined. The profile model is characterized using a set of profile parameters. The profile parameters of the set of profile parameters are varied to generate hypothetical profiles of varying shapes and sizes.

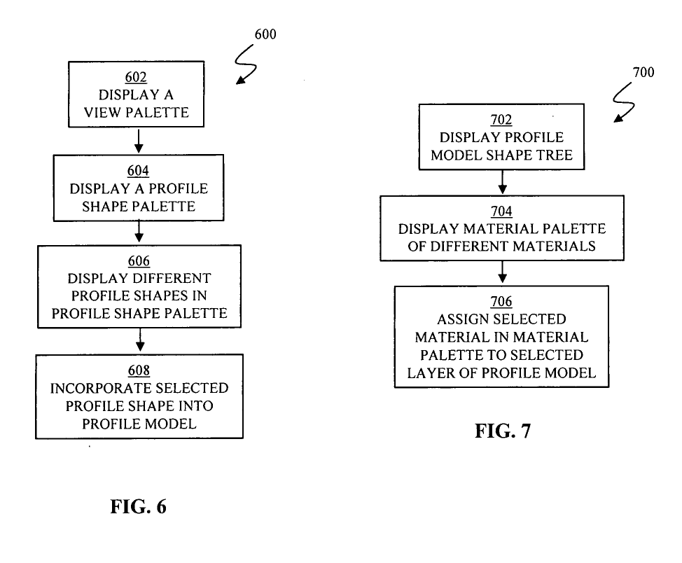

With reference to FIG. 6, an exemplary process 600 is depicted of generating a profile model before using the profile model to generate hypothetical profiles in a library-based process or a regression-based process of determining features of a structure. It should be recognized, however, that exemplary process 600 can be used to generate a profile model at various times and for various reasons.

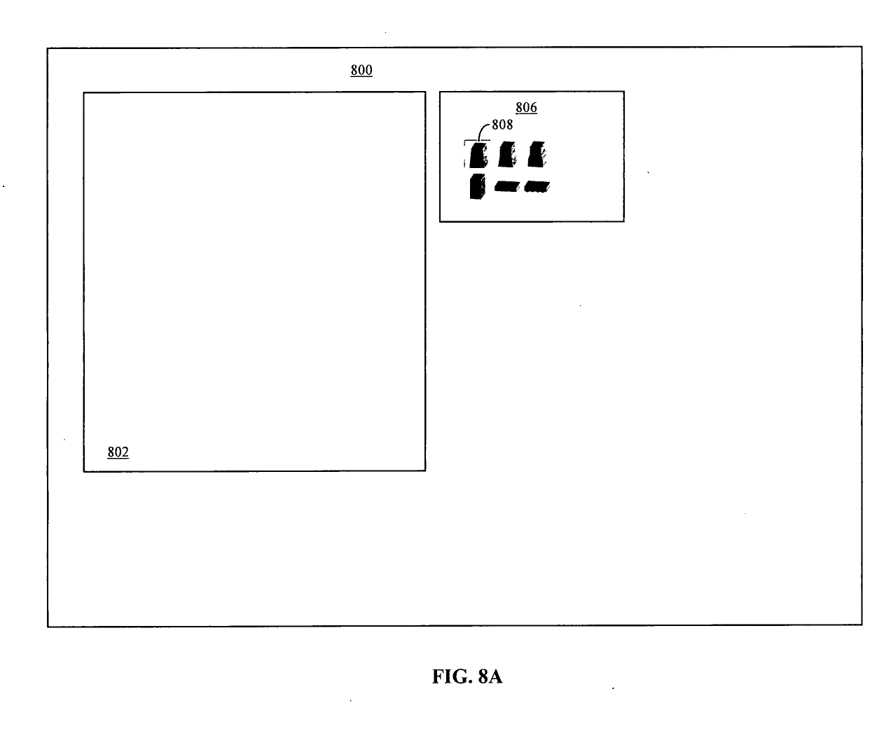

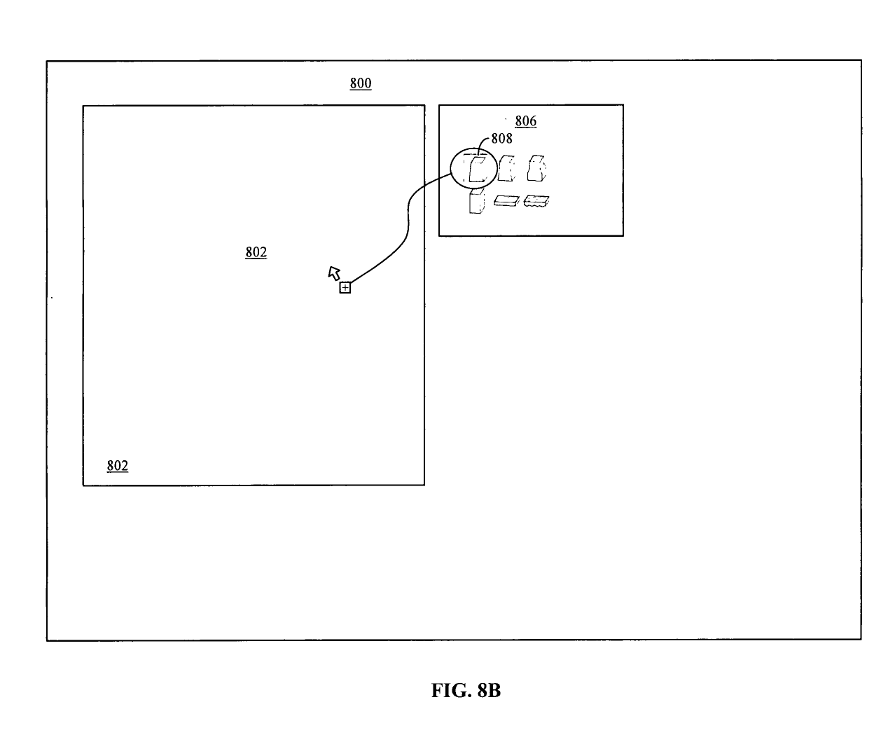

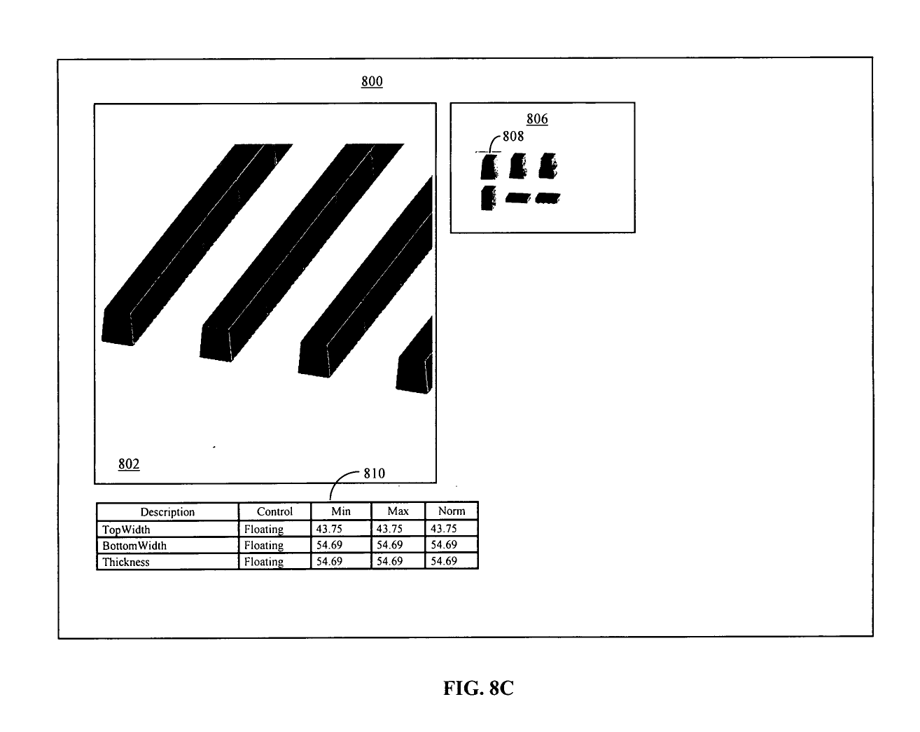

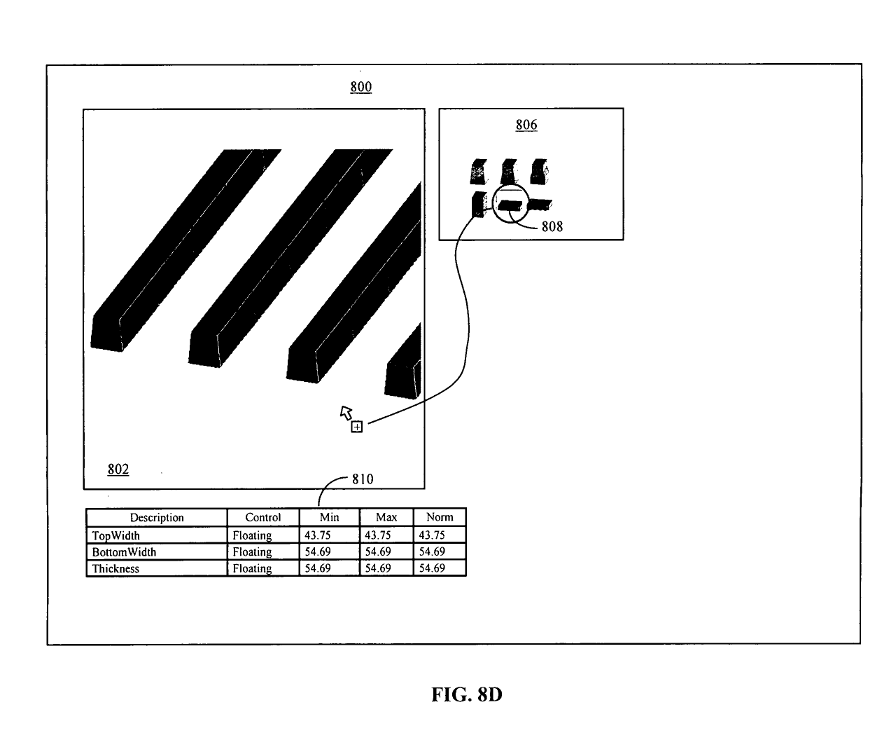

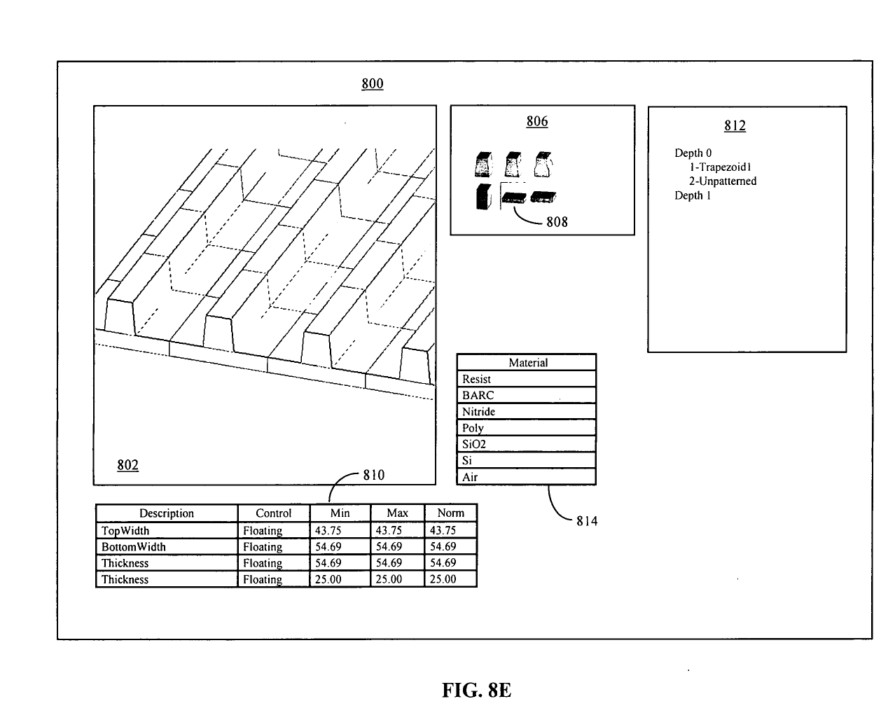

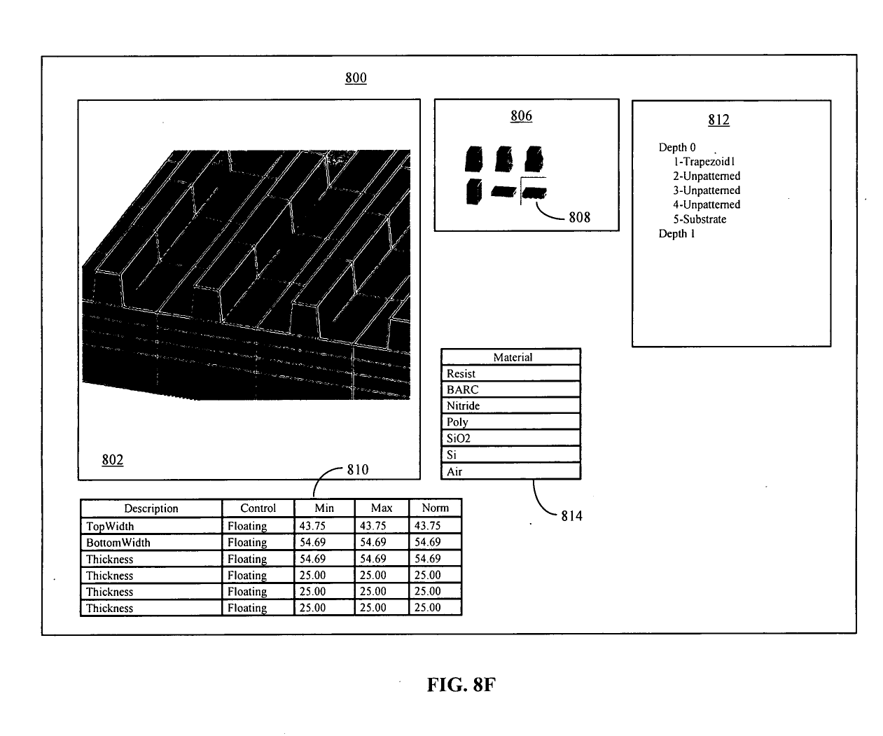

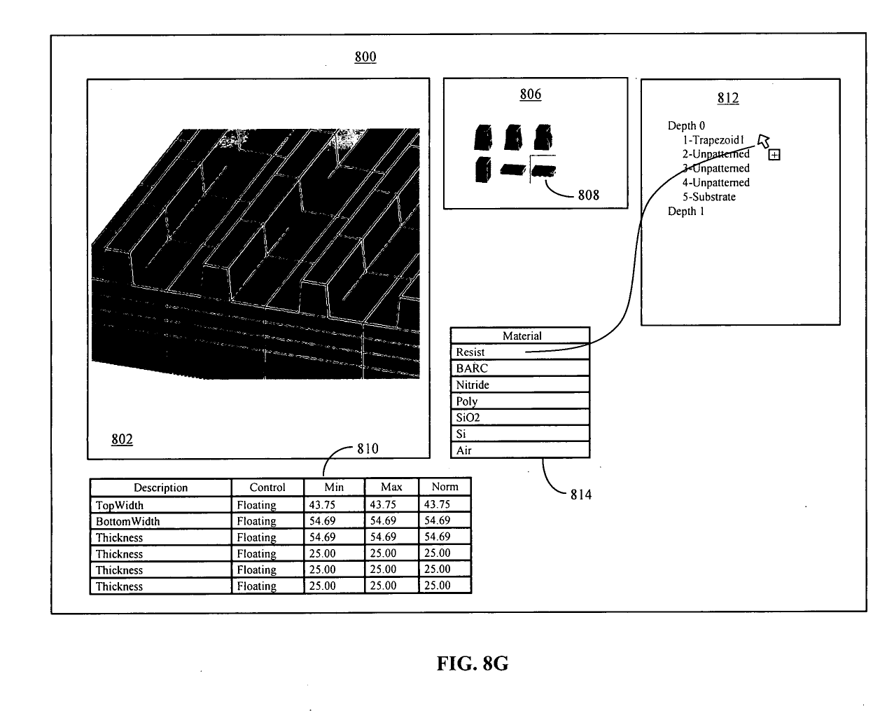

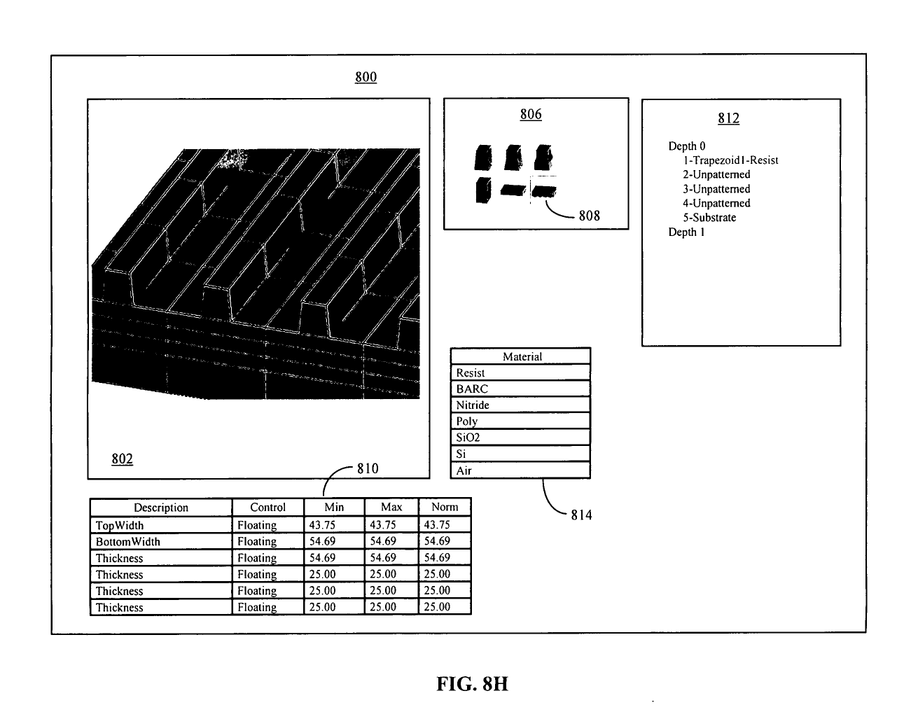

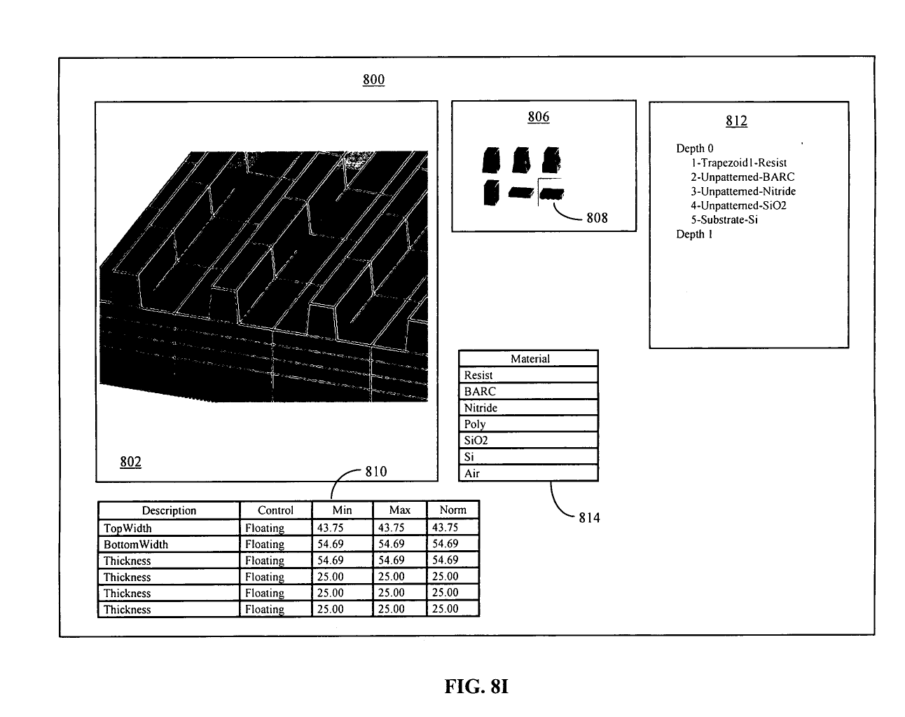

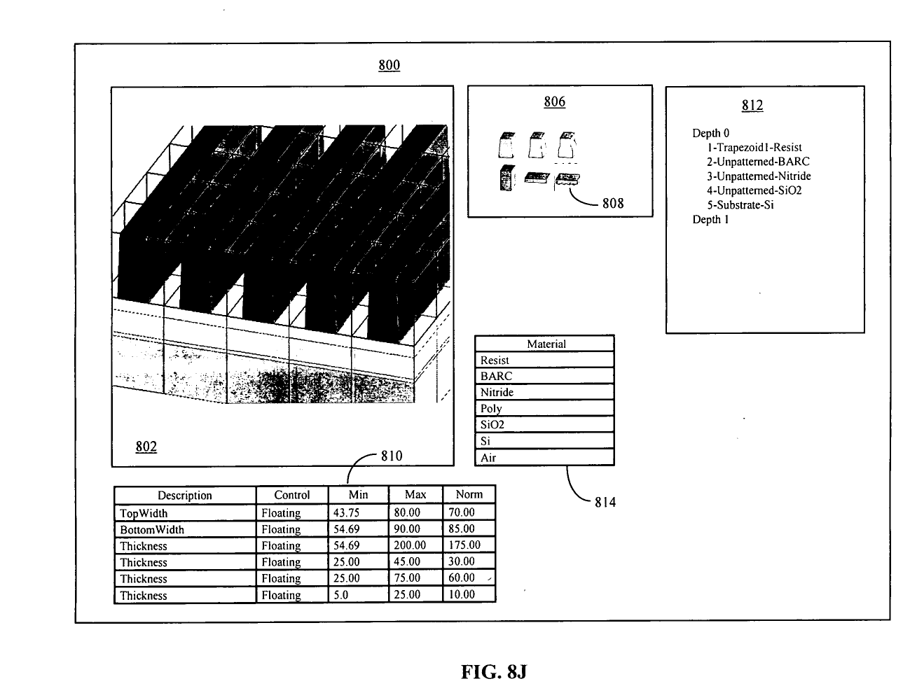

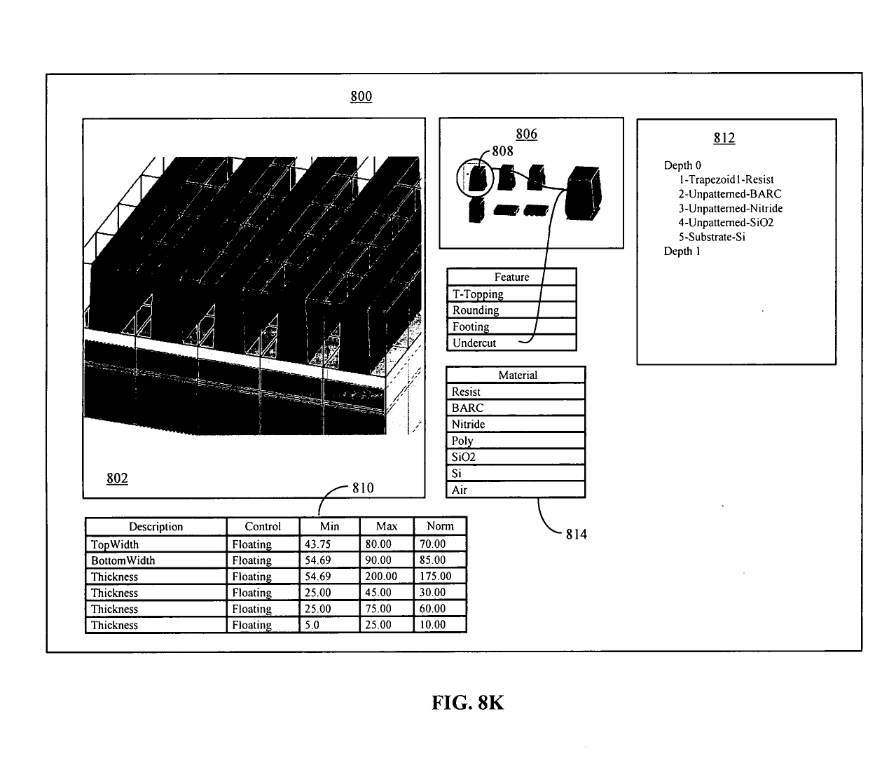

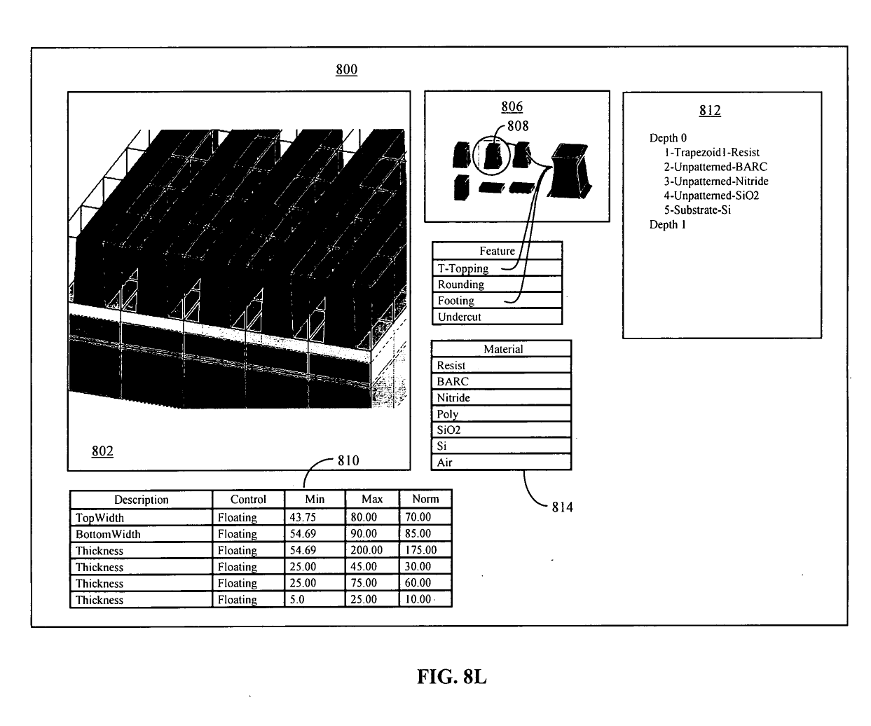

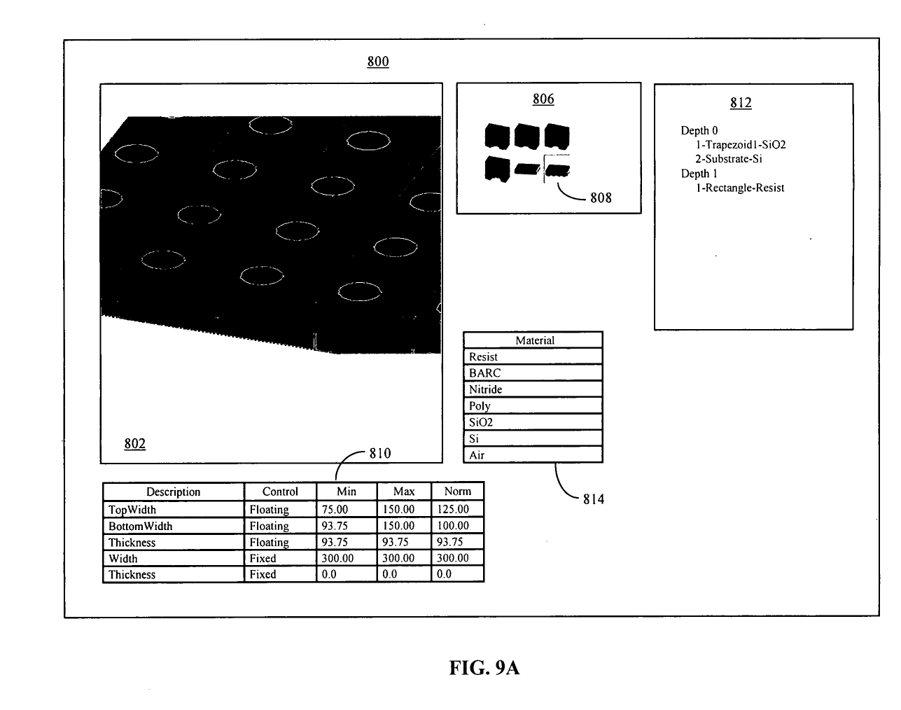

In step 602, a view canvas is displayed. As will be described in more detail below, the profile model being generated is displayed in the view canvas. FIG. 8A depicts a display 800 with a view canvas 802 displayed.

With reference again to FIG. 6, in step 604, a profile shape palette is displayed. FIG. 8A depicts a profile shape palette 806 displayed in display 800 adjacent to view canvas 802. In FIG. 8A, profile shape palette 806 is displayed immediately adjacent to view canvas 802. It should be recognized, however, that any number of display items can be displayed between profile shape palette 806 and view canvas 802 in display 800. Additionally, it should be recognized that profile shape palette 806 and view canvas 802 can be re-sized and moved within display 800.

With reference again to FIG. 6, in step 606, a plurality of different profile shape primitives are displayed in the profile shape palette. Each of the profile shape primitives in the profile shape palette is defined by a set of profile parameters. FIG. 8A depicts different profile shape primitives 808 displayed in profile shape palette 806. In the present example, six different profile shape primitives 808 are displayed in profile shape palette 806. It should be recognized, however, that any number of different profile shape primitives 808 can be displayed in profile shape palette 806.

In one exemplary embodiment, a set of profile features for the profile shape primitives is displayed. When a user selects one of the set of profile features and a profile shape primitive from the profile shape palette, the selected profile feature is applied to the selected profile shape primitive. For example, FIG. 8K depicts a set of profile features 816 that includes t-top, rounding, footing, and undercut features. For the sake of example, as depicted in FIG. 8K, assume a user selects the undercut feature from set of profile features 816 and a profile shape primitive 808 corresponding to a trapezoidal shape (hereafter referred to as the trapezoidal profile shape primitive 808) from profile shape palette 806. Thus, in the present example, as depicted in FIG. 8K, the undercut feature is applied to the trapezoidal profile shape primitive 808. FIG. 8L depicts a further example of the t-top feature being selected and applied.

With reference again to FIG. 6, in step 608, when a user selects a profile shape primitive in the profile shape palette, drags the selected profile shape primitive from the profile shape palette, and drops the selected profile shape primitive into the view canvas, the selected profile shape primitive is incorporated into the profile model being generated and displayed in the view canvas. For example, with reference to FIG. 8B, assume a user selects trapezoidal profile shape primitive 808 from profile shape palette 806. As depicted in FIG. 8B, assume the user drags the selected trapezoidal profile shape primitive 808 from the profile shape palette 806 and drops the selected trapezoidal profile shape primitive 808 into view canvas 802. As depicted in FIG. 8C, the selected trapezoidal profile shape primitive 808 is incorporated into the profile model being generated and displayed in view canvas 802. Also, the set of profile parameters that defines the selected trapezoidal profile shape primitive 808 is incorporated into the set of profile parameters that defines the profile model being generated. As also depicted in FIG. 8C, in the present example, multiple periods of trapezoidal profile shape primitive 808 are displayed in view canvas 802. It should be recognized, however, that any number of periods, including one period, can be displayed in view canvas 802.

In the present example, trapezoidal profile shape primitive 808 is the first profile shape primitive that is selected for the profile model being generated. Thus, in the present example, view canvas 802 is blank before trapezoidal profile shape primitive 808 is incorporated into the profile model being generated. FIGS. 8D and 8E, however, depict another profile shape primitive being selected and incorporated into the profile model being generated. In particular, FIG. 8D depicts a profile shape primitive 808 corresponding to an unpatterned layer (hereafter referred to as unpatterned layer profile shape primitive 808) being selected from profile shape palette 806. FIG. 8E depicts the selected unpatterned layer profile shape primitive 808 incorporated into the profile model being generated and displayed in view canvas 802.

FIG. 8F depicts two additional unpatterned layer profile shape primitives 808 and a substrate profile shape primitive 808 incorporated into the profile model being generated and displayed in view canvas 802. Thus, in the manner described above, a profile model for a complicated structure (in the example above, a structure having three unpatterned layers formed on top of a substrate with a patterned structure formed on the three unpatterned layers) can be generated using the pre-generated profile shape primitives 808 in profile shape palette 806.

With reference again to FIG. 8C, in one exemplary embodiment, the one or more sets of profile parameters that define the one or more profile shape primitives that comprise the profile model being generated are displayed. In the present example, the one or more sets of profile parameters are displayed as a profile model definition table 810. In particular, as depicted in FIG. 8C, when trapezoidal profile shape primitive 808 is incorporated into the profile model being generated, the set of profile parameters that defines the trapezoidal profile shape primitive 808 is displayed in profile model definition table 810. In the present example, trapezoidal profile shape primitive 808 is defined by a TopWidth profile parameter, a BottomWidth profile parameter, and a Thickness profile parameter. As depicted in FIG. 8E, when unpatterned layer profile shape primitive 808 is incorporated into the profile model being generated, the set of profile parameters that defines the unpatterned layer profile shape primitive 808 is displayed in profile model definition table 810. In the present example, unpatterned layer profile shape primitive 808 is defined by another Thickness profile parameter.

As depicted in FIG. 8F, when two additional unpatterned layer profile shape primitives 808 and a substrate profile shape primitive 808 are incorporated into the profile model being generated, the sets of profile parameters that define the two additional unpatterned layer profile shape primitives 808 and substrate profile shape primitive 808 are displayed in profile model definition table 810. In the present example, two additional unpatterned profile shape primitives 808 and substrate profile shape primitive 808 are defined by additional Thickness profile parameters. Thus, the sets of profile parameters that define the profile model being generated can be assembled based on the profile shape primitives selected from the profile shape palette.

With continued reference to FIG. 8F, in the present exemplary embodiment, for each profile parameter in the one or more sets of profile parameters displayed in profile model definition table 810, an indication of whether the profile parameter has a fixed value or a floating value is displayed. In the present example, the TopWidth profile parameter, a BottomWidth profile parameter, and Thickness parameters are indicated as being floating values.

In the present exemplary embodiment, for each profile parameter in the one or more sets of profile parameters displayed in profile model definition table 810 that have floating values, a minimum value and a maximum value are displayed. Additionally, for each profile parameter in the one or more sets of profile parameters displayed in profile model definition table 810 that has a floating value, a nominal value is displayed.

In the present exemplary embodiment, when the minimum and/or maximum values of a profile parameter are adjusted by a user, the profile model displayed in the view canvas is modified accordingly. For example, FIG. 8J depicts the maximum values of the TopWidth profile parameter, the BottomWidth profile parameter, and three of the four Thickness parameters have been adjusted by a user. The minimum value of the remaining Thickness parameter has also been adjusted by the user. As depicted in FIG. 8J, the profile model displayed in view canvas 802 is modified accordingly.

In one exemplary embodiment, the profile model can be generated or revised using the profile model definition table. In particular, a profile shape primitive can be added to the profile model by selecting the profile shape primitive from the profile shape palette, dragging the selected profile shape primitive from the profile shape palette, and dropping the selected profile shape primitive into the profile model definition table.

With reference to FIG. 7, an exemplary process 700 is depicted of assigning materials to one or more layers of the profile model being generated. For the sake of example, exemplary process 700 will be described below in conjunction the profile model generated in the example above, which is depicted in FIG. 8F. It should be recognized, however, that exemplary process 700 can be used to assign materials to one or more layers of various profile models being generated.

With reference again to FIG. 7, in step 702, a profile model shape tree of the profile model being generated is displayed. The profile model shape tree lists the different layers that make up the profile model being generated. For example, FIG. 8F depicts a profile model shape tree 812 of the profile model being generated and displayed in view canvas 802. In particular, in the present example, profile model shape tree 812 includes one trapezoid layer, three unpatterned layers, and a substrate layer.

In one exemplary embodiment, the profile model can be generated or revised using the profile model shape tree. In particular, a profile model can be generated by selecting a profile shape primitive from the profile shape palette 806, dragging the selected profile shape primitive from the profile shape palette, and dropping the selected profile shape primitive into the profile model shape tree. The selected profile shape primitive is then incorporated into the profile model being generated. Additionally, the profile model being generated can be revised by removing, deleting, or reordering one or layers listed in the profile model shape tree. For example, when an entry in the model shape tree is removed or deleted, the layer in the profile model corresponding to the entry is removed or deleted from the profile model being generated. As a further example, assume the layers of the profile model being generated are a rectangle layer, a trapezoid layer, another rectangle layer, and a substrate layer, in this order. By dragging the lower rectangle up and dropping it above the trapezoid in the profile model shape tree, a user can revise the layers of the profile model being generated to now be a rectangle layer, another rectangle layer, a trapezoid layer, and a substrate layer.

With reference again to FIG. 7, in step 704, a material palette of different materials is displayed. FIG. 8F depicts a material palette 814 of different materials. In particular, in the present example, material palette 814 includes resist, bottom antireflective coating (BARC), nitride, poly, silicon-dioxide (SiO2), silicon (Si), and air. It should be recognized, however, that material palette 814 can include any type of material and any number of materials.

With reference again to FIG. 7, in step 706, when a user selects a material in the material palette and a layer of the profile model in the model shape tree, the selected material in the material palette is assigned to the selected layer of the profile model. In particular, in the present exemplary embodiment, when a user selects a material in the material palette, drags the material from the material palette, and drops the selected material into the layer of the profile model in the model shape tree, the selected material is assigned to the selected layer of the profile model. FIG. 8G depicts an example of the resist material being selected from material palette 814 and dropped into the trapezoid layer of the profile model being generated and displayed in view canvas 802. FIG. 8H depicts the resist material having been assigned to the trapezoid layer of the profile model being generated and displayed in view canvas 802.

In one exemplary embodiment, a selected material is assigned to a selected layer of the profile model when a user selects a material in the material palette, drags the selected material from the material palette, and drops the selected material into the layer of the profile model displayed in the view canvas. Alternatively, a selected material is assigned to a selected layer of the profile model when a user selects a material in the material palette, drags the selected material from the material palette, and drops the selected material into an in the model definition table corresponding to the selected layer.

In the manners described above, materials can be assigned to all the layers of the profile model being generated and displayed in the view canvas. In the present example, FIG. 8I depicts all the layers of the profile model being generated and displayed in view canvas 802 having been assigned materials from material palette 814.

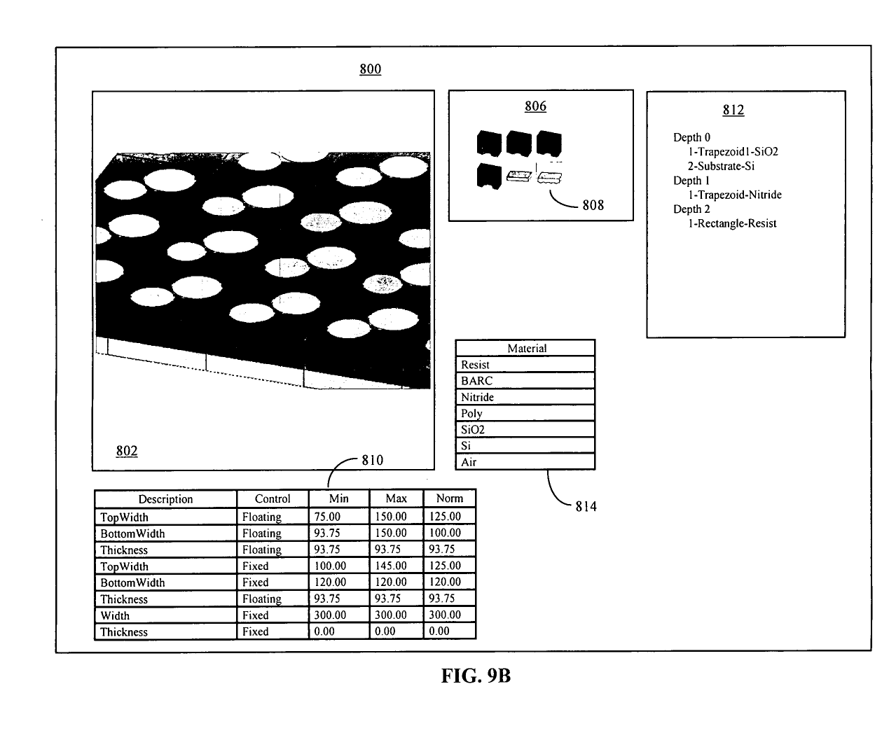

As described above, a profile can vary in only one dimension or in two or more dimensions. Thus, in one exemplary embodiment, the profile shape palette includes profile shape primitives of profiles that vary in only one dimension and profile shape primitives of profiles that vary in two or more dimensions. For example, FIG. 9A depicts profile shape palette 806 with profile shape primitives 808 that vary in two or more dimensions. In particular, FIG. 9A depicts profile shape palette 806 with profile shape primitives 808 corresponding to contact holes of varying shapes. FIG. 9A also depicts a profile model comprised of a unit cell with a contact hole. FIG. 9B depicts a profile model comprised of a unit cell with two contact holes.

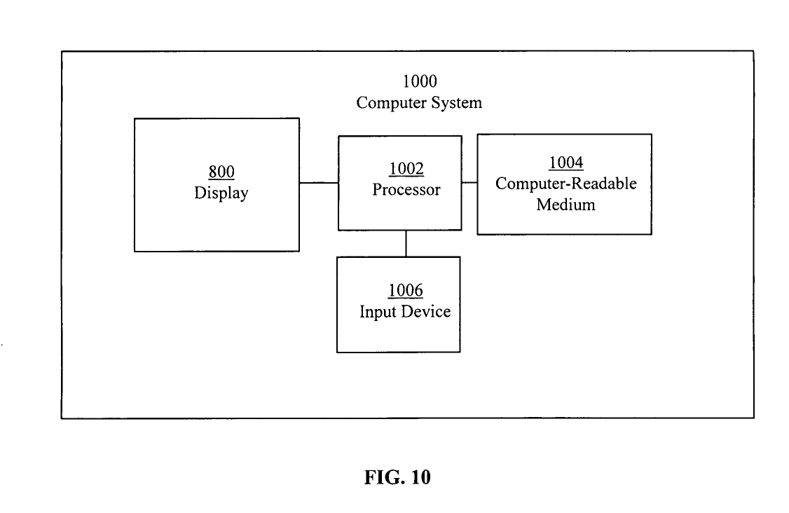

With reference to FIG. 10, in the present exemplary embodiment, display 800 can be a component of a computer system 1000. As depicted in FIG. 10, computer system 1000 can include a processor 1002 that is configured to perform process 600 (FIG. 6) and/or process 700 (FIG. 7). Computer system 1000 can also include a computer-readable medium 1004, such as a hard disk, solid date memory, etc., that can include computer-executable instructions to direct the operation of processor 1002 in performing process 600 (FIG. 6) and/or process 700 (FIG. 7). Computer system 1000 can further include an input device 1006 configured to receive input from the user.

It should be recognized that computer system 1000 can include various additional components not depicted in FIG. 10. Additionally, it should be recognized that computer system 1000 can be physically embodiment in various forms. For example, computer system 1000 can be a unitary computer, such as a workstation, or can be part of a distributed computer system.

Although exemplary embodiments have been described, various modifications can be made without departing from the spirit and/or scope of the present invention. Therefore, the present invention should not be construed as being limited to the specific forms shown in the drawings and described above.

We claim:

1. A method of generating a profile model to characterize a structure to be examined using optical metrology, the method comprising:
a) displaying a view canvas, wherein the profile model being generated is displayed in the view canvas;
b) displaying a profile shape palette adjacent to the view canvas;
c) displaying a plurality of different profile shape primitives in the profile shape palette, wherein each profile shape primitive in the profile shape palette is defined by a set of profile parameters; and
d) when a user selects a profile shape primitive from the profile shape palette, drags the selected profile shape primitive from the profile shape palette, and drops the selected profile shape primitive into the view canvas, incorporating the selected profile shape primitive into the profile model being generated and displayed in the view canvas.

2. The method of claim 1, wherein multiple periods of the profile model being generated are displayed in the view canvas.

3. The method of claim 1, wherein c) comprises:
displaying a first plurality of different profile shape primitives in the profile shape palette, wherein the different profile shape primitives in the first plurality of different profile shape primitives are of profiles that vary in only one dimension; and
displaying a second plurality of different profile shape primitives in the profile shape palette, wherein the different profile shape primitives in the second plurality of different profile shape primitives are of profiles that vary in two dimensions.

4. The method of claim 1, wherein the profile model being generated is defined by a set of profile parameters, and d) comprises:
incorporating the set of profile parameters that defines the selected profile shape primitive into the set of profile parameters that defines the profile model being generated.

5. The method of claim 4, further comprising:
displaying one or more sets of profile parameters that define the one or more profile shape primitives that comprise the profile model being generated.

6. The method of claim 5, further comprising:
for each profile parameter in the one or more sets of profile parameters displayed, displaying whether the profile parameter has a fixed value or a floating value.

7. The method of claim 6, further comprising:
for each profile parameter in the one or more sets of profile parameters displayed that has a floating value, displaying a minimum value and a maximum value for a range of values for the profile parameter.

8. The method of claim 7, further comprising:
when the minimum value or the maximum value for a profile parameter is adjusted, modifying the profile model being adjusted.

9. The method of claim 7, further comprising:
for each profile parameter in the one or more sets of profile parameters displayed that has a floating value, displaying a nominal value for a range of values for the profile parameter.

10. The method of claim 1, further comprising:
displaying a set of profile features to be applied to a profile shape primitive in the profile shape palette, wherein, when a user selects a profile feature from the displayed set of profile features and a profile shape primitive from the profile shape palette, the selected feature is applied to the selected profile shape primitive.

11. The method of claim 10, wherein the set of profile features includes t-top, rounding, footing, and undercut features.

12. The method of claim 10, wherein the set of profile features is displayed in the profile shape palette.

13. The method of claim 1, further comprising:
displaying a model shape tree of the profile model being generated, wherein the model shape tree lists one or more different layers that make up the profile model being generated.

14. The method of claim 13, further comprising:
when an entry in the model shape tree is removed or deleted, removing or deleting the layer corresponding to the entry from the profile model being generated.

15. The method of claim 13, further comprising:
when entries in the model shape tree are reordered, reordering the layers corresponds to the reordered entries in the profile model being generated.

16. The method of claim 13, further comprising:
when a user selects a profile shape primitive from the profile shape palette, drags the selected profile shape primitive from the profile shape palette, and drops the selected profile shape primitive into the model shape tree, incorporating the selected profile shape primitive into the profile model being generated.

17. The method of claim 13, further comprising:
displaying a material palette of different materials; and
when a user selects a material in the material palette and a layer of the profile model in the model shape tree, assigning the selected material in the material palette to the selected layer of the profile model.

18. The method of claim 1, further comprising:
displaying a material palette of different materials; and
when a user selects a material in the material palette, drags the selected material from the material palette, and drops the selected material into a layer of the profile model displayed in the view canvas, assigning the selected material to the layer of the profile model.

19. The method of claim 1, further comprising:
displaying a model definition table listing profile parameters of layers of the profile model being generated;
displaying a material palette of different materials; and
when a user selects a material in the material palette, drags the selected material from the material palette, and drops the selected material into an entry in the model definition table, assigning the selected material to a layer of the profile model that corresponds to the entry in the model definition table.

20. The method of claim 1, further comprising:
displaying a model definition table listing profile parameters of layers of the profile model being generated;
when a user selects a profile shape primitive from the profile shape palette, drags the selected profile shape primitive from the profile shape palette, and drops the selected profile shape primitive into the model definition table, incorporating the selected profile shape primitive into the profile model being generated.

21. A computer-readable medium containing computer-executable instructions for generating a profile model to characterize a structure to be examined using optical metrology, comprising instructions for:
a) displaying a view canvas, wherein the profile model being generated is displayed in the view canvas;
b) displaying a profile shape palette adjacent to the view canvas;
c) displaying a plurality of different profile shape primitives in the profile shape palette, wherein each profile shape primitive in the profile shape palette is defined by a set of profile parameters; and
d) when a user selects a profile shape primitive from the profile shape palette, drags the selected profile shape primitive from the profile shape palette, and drops the selected profile shape primitive into the view canvas, incorporating the selected profile shape primitive into the profile model being generated and displayed in the view canvas.

22. The computer-readable medium of claim 21, wherein c) comprises instructions for:
displaying a first plurality of different profile shape primitives in the profile shape palette, wherein the different profile shape primitives in the first plurality of different profile shape primitives are of profiles that vary in only one dimension; and
displaying a second plurality of different profile shape primitives in the profile shape palette, wherein the different profile shape primitives in the second plurality of different profile shape primitives are of profiles that vary in two dimensions.

23. The computer-readable medium of claim 21, further comprising instructions for:
displaying one or more sets of profile parameters that define the one or more profile shape primitives that comprise the profile model being generated.

24. The computer-readable medium of claim 21, further comprising instructions for:
displaying a set of profile features to be applied to a profile shape primitive in the profile shape palette, wherein, when a user selects a profile feature from the displayed set of profile features and a profile shape primitive from the profile shape palette, the selected feature is applied to the selected profile shape primitive.

25. The computer-readable medium of claim 21, further comprising instructions for:
displaying a model shape tree of the profile model being generated, wherein the model shape tree lists one or more different layers that make up the profile model being generated;
displaying a material palette of different materials; and
when a user selects a material in the material palette and a layer of the profile model in the model shape tree, assigning the selected material in the material palette to the selected layer of the profile model.

26. The computer-readable medium of claim 21, further comprising instructions for:
displaying a model shape tree of the profile model being generated, wherein the model shape tree lists one or more different layers that make up the profile model being generated; and
when a user selects a profile shape primitive from the profile shape palette, drags the selected profile shape primitive from the profile shape palette, and drops the selected profile shape primitive into the model shape tree, incorporating the selected profile shape primitive into the profile model being generated.

27. The computer-readable medium of claim 26, further comprising instructions for:
when an entry in the model shape tree is removed or deleted, removing or deleting the layer corresponding to the entry from the profile model being generated; and
when entries in the model shape tree are reordered, reordering the layers corresponds to the reordered entries in the profile model being generated.

28. The computer-readable medium of claim 21, further comprising instructions for:
displaying a material palette of different materials; and
when a user selects a material in the material palette, drags the selected material from the material palette, and drops the selected material into a layer of the profile model displayed in the view canvas, assigning the selected material to the layer of the profile model.

29. The computer-readable medium of claim 21, further comprising instructions for:
displaying a model definition table listing profile parameters of layers of the profile model being generated;
displaying a material palette of different materials; and
when a user selects a material in the material palette, drags the selected material from the material palette, and drops the selected material into an entry in the model definition table, assigning the selected material to a layer of the profile model that corresponds to the entry in the model definition table.

30. The computer-readable medium of claim 21, further comprising instructions for:
displaying a model definition table listing profile parameters of layers of the profile model being generated;
when a user selects a profile shape primitive from the profile shape palette, drags the selected profile shape primitive from the profile shape palette, and drops the selected profile shape primitive into the model definition table, incorporating the selected profile shape primitive into the profile model being generated.

31. A system for generating a profile model to characterize a structure to be examined using optical metrology, the system comprising:
a display; and
a processor connected to the display and configured to:
a) display a view canvas, wherein the profile model being generated is displayed in the view canvas;
b) display a profile shape palette adjacent to the view canvas;
c) display a plurality of different profile shape primitives in the profile shape palette, wherein each profile shape primitive in the profile shape palette is defined by a set of profile parameters; and
d) when a user selects a profile shape primitive from the profile shape palette, drags the selected profile shape primitive from the profile shape palette, and drops the selected profile shape primitive into the view canvas, incorporate the selected profile shape primitive into the profile model being generated and displayed in the view canvas.

32. The system of claim 31, wherein the processor is configured to:
display a model shape tree of the profile model being generated, wherein the model shape tree lists one or more different layers that make up the profile model being generated;
display a material palette of different materials; and
when a user selects a material in the material palette and a layer of the profile model in the model shape tree, assign the selected material in the material palette to the selected layer of the profile model.
